(19) United States
(12) Patent Application Publication
(10) Pub. No.: US 2026/0135696 A1
(43) Pub. Date: May 14, 2026

(54) METHOD AND SYSTEM FOR ADAPTIVE AUTHENTICATION AND KEY AGREEMENT IN CLOUD-EDGE-DEVICE ENVIRONMENTS

(71) Applicant: Beijing University of Posts and Telecommunications, Beijing (CN)

(72) Inventors: Jianfeng Guan, Beijing (CN); Su Yao, Beijing (CN); Mu Wang, Beijing (CN); Kexian Liu, Beijing (CN); Yizhong Hu, Bijie (CN); Ao Shen, Beijing (CN); Xiaolong Hu, Ji 'an (CN); Jianli Liu, Longyan (CN); Ye Qin, Changde (CN)

(21) Appl. No.: 19/382,214

(22) Filed: Nov. 6, 2025

(30) Foreign Application Priority Data
Nov. 14, 2024 (CN) 202411626169.8

(51) Int. Cl. H04L 9/08; H04L 9/32

(52) U.S. Cl. CPC H04L 9/0866; H04L 9/0838; H04L 9/3236

(57) ABSTRACT

A method and system for adaptive authentication and key agreement in cloud-edge-device environments are provided. The method includes: utilizing a trust authority to perform identity registration for users, devices, edge servers, and cloud servers; after identity registration is completed, a user logs into a device and sends the user's request information to edge servers within range through the logged-in device; upon receiving the request information, the edge server provides service to the user: determining whether the edge server's service capability satisfies the request information; if yes, performing authentication and key agreement between the edge server and the user's logged-in device, and providing service to the user after completion; if no, selecting a cloud server to perform authentication and key agreement with the user's logged-in device, and providing service to the user after completion. The disclosure can adaptively execute different authentication methods, devices only need to send one authentication request to satisfy requirements, reducing redundant authentication of devices, reducing the load on Trust Authority (TA) while protecting device privacy.

### TECHNICAL FIELD

The disclosure relates to the field of network security technology, and more particularly to an adaptive authentication and key agreement method for cloud-edge-device environments.

### BACKGROUND

Cloud computing has become an important means of satisfying people's diverse needs, with widespread applications spanning from online medical diagnosis to video transmission from dashboard cameras, to everyday conversations, and various other domains. While cloud computing offers significant advantages in providing diverse services, it still presents certain limitations for highly time-sensitive operations. For example, cloud computing often fails to achieve expected performance in real-time data processing and low-latency communications. To address these challenges, edge computing has emerged. Edge computing effectively reduces latency and improves real-time performance by moving computation and data storage closer to the network edge, thereby satisfying users' requirements for time-sensitive operations. However, edge computing itself has limited computational and storage capabilities and still requires cloud computing support when processing large-scale, complex tasks.

Today, the optimization and advancement of cloud-edge-device architectures have become a research hotspot. Cloud-edge-device collaborative computing technology combines the advantages of both cloud computing and edge computing, simultaneously meeting users' diverse requirements for real-time performance and computational capability, making it an inevitable trend in Internet of Things development. However, the existing technology suffers from the following deficiencies:
(1) Single-scenario authentication: Currently, some authentication schemes exist in cloud-edge-device environments, such as device-to-edge authentication schemes and device-to-cloud authentication schemes. However, these schemes typically apply only to single scenarios, for example, considering only authentication between edge and user devices or between cloud and user devices, without considering comprehensive cloud-edge-device collaborative scenarios. Due to the complexity of cloud-edge-device collaborative scenarios, where users may require edge computing for time-sensitive operations while needing cloud computing assistance for computationally intensive and high-storage-demand operations, there is a need for a scalable, adaptive, and highly available cloud-edge-device collaborative authentication scheme. Furthermore, due to different requirements for system initialization and encryption algorithms, integration difficulty increases, making it challenging to integrate these single-scenario schemes into a unified cloud-edge-device framework.
(2) Trust authority overload: Frequent interactions with Trust Authorities (TAs) or registration centers during the authentication process result in overloaded TAs and registration centers, potentially causing security issues.
(3) Complex operations unsuitable for resource-constrained devices: The use of complex Elliptic Curve Cryptography (ECC) operations and bilinear pairings in the authentication process is unfriendly to resource-constrained devices, increasing deployment difficulty.

### SUMMARY

The purpose of the disclosure is to provide an adaptive identity authentication and key agreement method for cloud-edge-device environments to solve the aforementioned problems existing in the prior art.

To achieve the above purpose, the disclosure provides an adaptive authentication and key agreement method for cloud-edge-device environments.

The method includes:
step S1: utilizing a trust authority to perform identity registration for users, devices, edge servers, and cloud servers; after identity registration is completed, a user logs into a device and sends the user's request information to edge servers within a predetermined range through the logged-in device;
step S2: upon receiving the request information, the edge server performs legitimacy verification on the device logged in by the user, and after verification passes, provides service to the user based on the request information.
step S3: during the process of providing service to the user, determining whether the edge server's service capability satisfies the request information; if yes, performing authentication and key agreement between the edge server and the user's logged-in device, and providing service to the user after the agreement is completed; if no, adaptively selecting a cloud server to perform authentication and key agreement with the user's logged-in device, and providing service to the user after the agreement is completed.

Optionally, before utilizing the trust authority to perform identity registration for users, devices, edge servers, and cloud servers, the method further comprises: utilizing the trust authority to initialize system hash computation Hash functions and publicly releasing the computed parameters within the network to complete system initialization.

Optionally, the identity registration process (the step S1) of the cloud server specifically comprises:
the cloud server submitting a cloud server registration request to the trust authority, wherein the cloud server registration request includes a cloud server identity identifier and types of services provided; upon receiving the cloud server registration request, the trust authority performs legitimacy verification on the cloud server identity identifier, and if legitimate, generates long-term public-private keys based on the cloud server identity identifier and calculates the cloud server's secret value based on hash operations; the trust authority stores the calculated secret value, public key, and service types, and sends the calculated secret value and private key to the cloud server, completing the cloud server's identity registration.

Optionally, the identity registration process (the step S1) of the edge server specifically comprises:
the edge server submitting an edge server registration request to the trust authority, wherein the edge server registration request includes an edge server identity identifier; upon receiving the edge server registration request, the trust authority performs legitimacy verification on the edge server identity identifier, and if legitimate, generates long-term public-private keys based on the edge server identity identifier and calculates the edge server's authentication credential based on hash operations; the trust authority generates associated authentication credentials corresponding to each cloud server for the edge server and returns a response message to the edge server, wherein the response message includes the edge server's private key, public identifiers of cloud server identities, authentication credentials, and pseudonyms for edge server-cloud server authentication; storing the edge server identity identifier, public key, and pseudonyms for edge server-cloud server authentication in the trust authority, completing the edge server's identity registration.

Optionally, the identity registration process (the step S1) of the user and the device specifically comprises:
the user selecting a username and password, performing hash operations on the username and password to obtain an encrypted password, and submitting the calculated encrypted password, username, device identifier, behavioral preferences, and geographic location as a user registration request to the trust authority;
upon receiving the user registration request, the trust authority calculating a unique communication identifier based on the username and device identifier, performing legitimacy verification on the unique communication identifier, and if legitimate, generating long-term public-private keys based on the unique communication identifier and generating associated authentication credentials corresponding to each edge server for the unique communication identifier based on behavioral preferences and geographic location;
calculating user login data on the device based on the username, device identifier, and password, causing the device to save the user login data, private key, and pseudonyms for unique communication identifier-edge server authentication, and causing the trust authority to store the unique communication identifier, username, device identifier, public key, and pseudonyms for unique communication identifier-edge server authentication, completing the identity registration of the user and the device.

Optionally, the user logging into the device specifically comprises:
the device calculating current user login data based on the username, device identifier, and password input by the user; if the current user login data is consistent with preset user login data, login succeeds; if the current user login data is inconsistent with preset user login data, login fails.

Optionally, step 3 specifically comprises:
the device initiating an authentication request to the edge server, wherein the authentication request includes a service request, pseudonym, first random number, timestamp, first message authentication code, and hash computation value, wherein the hash computation value is obtained by performing hash operations on the service request, pseudonym, random number, and timestamp;
upon receiving the authentication request, the edge server determining whether the timestamp has expired; if expired, rejecting the authentication request; if not expired, calculating a current hash computation value and determining whether the current hash computation value is consistent with the hash computation value in the authentication request; if inconsistent, authentication fails; if consistent, authentication succeeds, if the edge server's service capability does not satisfy the request information, selecting a cloud server to perform authentication and key agreement with the user's logged-in device and providing service to the user after the agreement is completed; if the edge server's service capability satisfies the request information, performing authentication and key agreement between the edge server and the user's logged-in device and providing service to the user after the agreement is completed.

Optionally, performing authentication and key agreement between the edge server and the user's logged-in device specifically comprises:
randomly generating a second random number, calculating a second message authentication code based on the second random number, generating a session key and extracting a current timestamp, calculating a hash value based on the second random number, current timestamp, and session key, and sending the calculated hash value, current timestamp, and second message authentication code as an authentication message to the device;
upon receiving the authentication message, the device determining whether the timestamp has expired; if expired, rejecting the authentication request; if not expired, calculating a current hash value based on the second message authentication code and comparing the current hash value with the hash value in the authentication message; if different, authentication fails; if identical, authentication passes and the session key is saved.

Optionally, adaptively selecting a cloud server to perform authentication and key agreement with the user's logged-in device specifically comprises:
calculating a third message authentication code, calculating a current hash value based on the third message authentication code, pseudonym, and timestamp, and sending the calculated hash value, third message authentication code, pseudonym, timestamp, and service type to the selected cloud server;
upon receiving the data, the cloud server determining whether the timestamp has expired; if expired, rejecting the authentication request; if not expired, calculating a fourth message authentication code and determining whether the current hash operation value is consistent with the hash value in the data received by the cloud server; if inconsistent, authentication fails; if consistent, authentication passes, and the calculated hash value, fourth message authentication code, and current timestamp are sent to the edge server for verification; determining whether the timestamp has expired; if expired, rejecting the authentication request; if not expired, calculating a fifth message authentication code and determining whether the current hash operation value is consistent with the hash value in the data received by the edge server; if inconsistent, authentication fails; if consistent, authentication passes, and the calculated hash value, fifth message authentication code, and current timestamp are sent to the device; upon receiving the data, the device determining whether the timestamp has expired; if expired, rejecting the authentication request; if not expired, calculating a current hash operation value based on the fifth message authentication code and determining whether the current hash operation value is consistent with the hash value in the data received by the device; if inconsistent, authentication fails; if consistent, authentication passes and the session key is saved.

### BRIEF DESCRIPTION OF DRAWINGS

To more clearly illustrate the technical solutions in the embodiments of the disclosure or in the prior art, the following briefly introduces the drawings required for use in the embodiments. Obviously, the drawings in the following description are merely some embodiments of the disclosure. For those of ordinary skill in the art, other drawings can be obtained based on these drawings without creative effort.

The drawings that form part of this application are used to provide further understanding of the disclosure. The illustrative embodiments of the disclosure and their descriptions are used to explain the disclosure and do not constitute improper limitations on the disclosure. In the drawings:

FIG. 1 is a flow chart of cloud server registration in an embodiment of the disclosure;

FIG. 2 is a flow chart of edge server registration in an embodiment of the disclosure;

FIG. 3 is a flow chart of user and device registration in an embodiment of the disclosure;

FIG. 4 is a flow chart of authentication and key agreement in an embodiment of the disclosure;

FIG. 5 is a flow chart of adaptive authentication and key agreement implementation in an embodiment of the disclosure.

### DETAILED DESCRIPTION OF EMBODIMENTS

Various exemplary embodiments of the disclosure are now described in detail. This detailed description should not be considered as limiting the disclosure, but should be understood as a more detailed description of certain aspects, characteristics, and implementations of the disclosure.

It should be understood that the terminology used in the disclosure is merely for describing particular embodiments and is not intended to limit the disclosure. Additionally, for numerical ranges in the disclosure, it should be understood that each intermediate value between the upper and lower limits of the range is also specifically disclosed. Intermediate values within any stated value or stated range and every smaller range between any other stated value or intermediate value within said range are also included within the disclosure. The upper and lower limits of these smaller ranges may independently be included or excluded from the range.

Unless otherwise indicated, all technical and scientific terms used herein have the same meanings as commonly understood by one of ordinary skill in the art to which this invention pertains. Although the disclosure describes only preferred methods, any methods similar or equivalent to those described herein may also be used in the practice or testing of the disclosure. All documents mentioned in this specification are incorporated by reference for the purpose of disclosing and describing methods related to such documents. In case of conflict with any incorporated document, the content of this specification shall prevail.

Various improvements and changes may be made to the specific embodiments of the disclosure specification without departing from the scope or spirit of the disclosure, which would be obvious to those skilled in the art. Other embodiments obtained from the specification of the disclosure would be obvious to those skilled in the art. The specification and examples of this application are exemplary only.

The terms “comprising,” “including,” “having,” “containing,” etc., used herein are all open-ended terms, meaning including but not limited to.

It should be noted that, in the absence of conflict, the embodiments in this application and the features in the embodiments may be combined with each other. The disclosure will be described in detail below with reference to the drawings and in combination with embodiments.

### Embodiment 1

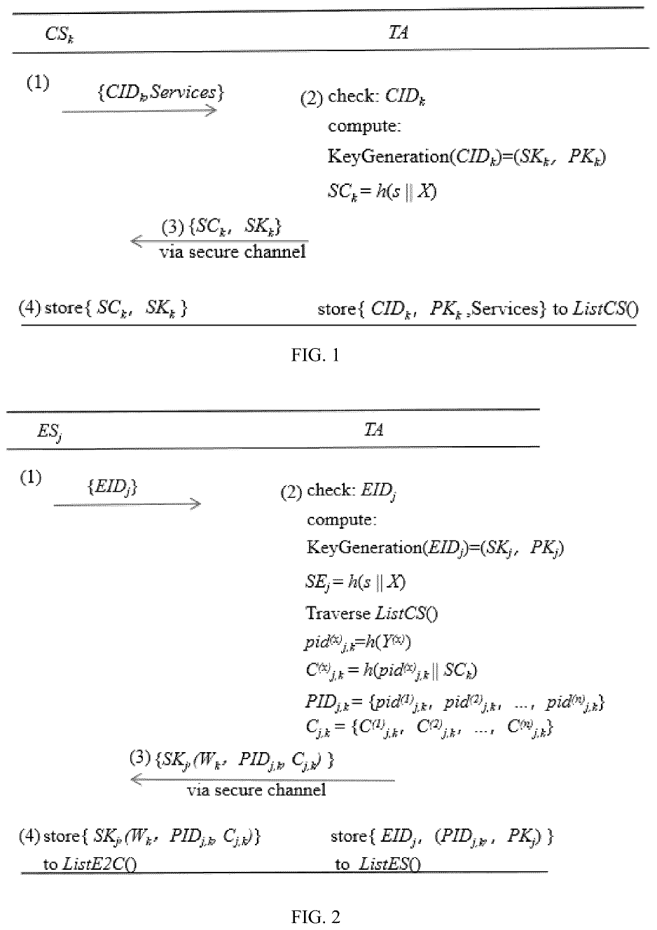

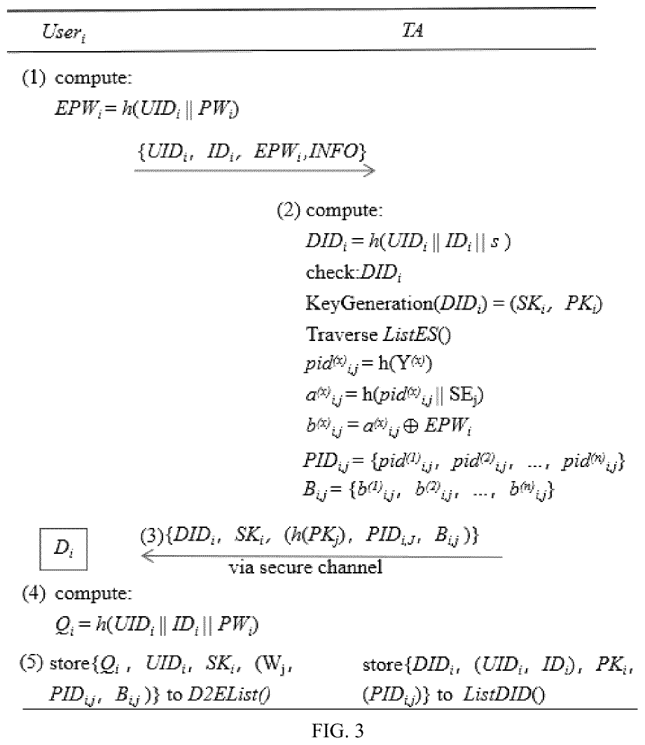

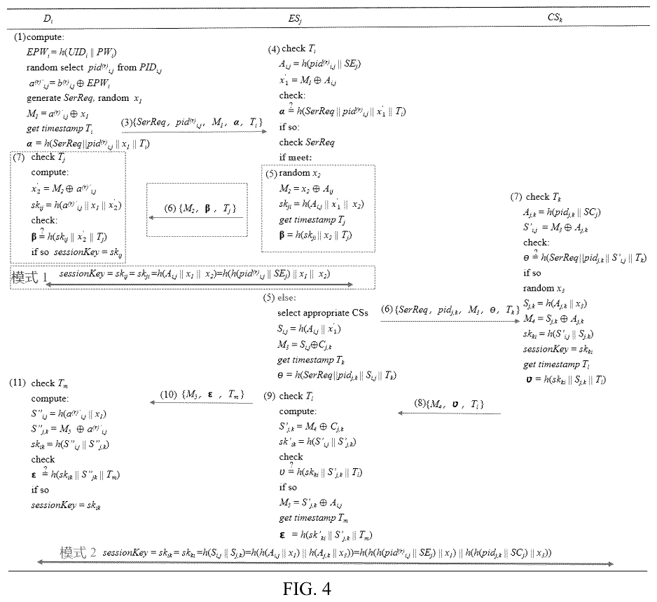

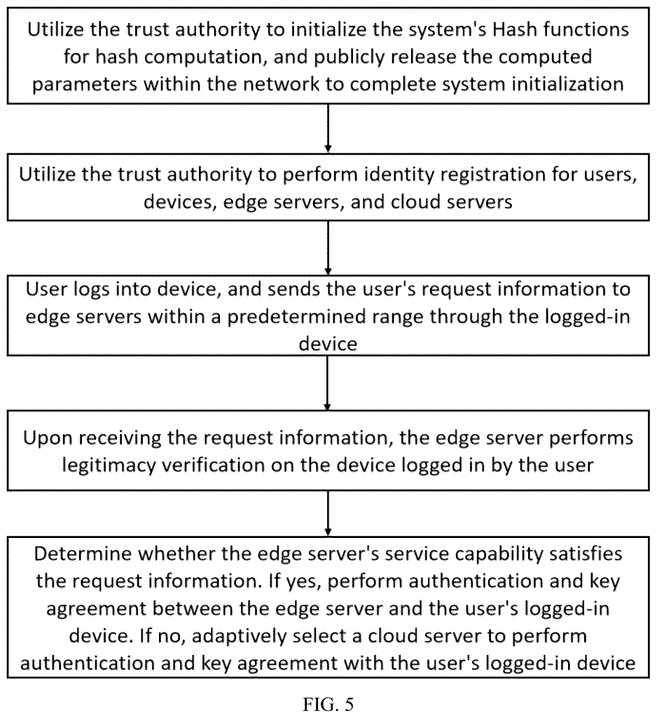

As shown in FIGS. 1-5, this embodiment provides an adaptive identity authentication and key agreement method for cloud-edge-device environments, comprising:
Step 1: utilizing a trust authority to perform identity registration for users, devices, edge servers, and cloud servers; after identity registration is completed, a user logs into a device and sends the user's request information to edge servers within a predetermined range through the logged-in device;
Step 2: upon receiving the request information, the edge server performs legitimacy verification on the device logged in by the user, and after verification passes, provides service to the user based on the request information;
Step 3: during the process of providing service to the user, determining whether the edge server's service capability satisfies the request information; if yes, performing authentication and key agreement between the edge server and the user's logged-in device, and providing service to the user after the agreement is completed; if no, selecting a cloud server to perform authentication and key agreement with the user's logged-in device, and providing service to the user after the agreement is completed.

Existing authentication scenarios under cloud-edge-device architectures are relatively singular, considering only authentication between cloud and user devices, or between edge and user devices, without considering cloud-edge-device collaborative scenarios. One consequence of this situation is: for example, if a user device first initiates a service request and authentication request to the edge, and the edge cannot satisfy the user device's service request, the user device still needs to resend service requests and authentication requests to the cloud.

This embodiment considers authentication under cloud-edge-device collaborative scenarios. User devices only need to send one authentication request message. If the edge satisfies the requirements, the user device directly performs identity authentication and key agreement with the edge. If the edge does not satisfy the requirements, the authentication message is adaptively processed and forwarded to an appropriate cloud, ultimately achieving identity authentication and key agreement between the cloud and user device, meaning the user device does not need to frequently or repeatedly send authentication request information.

To address the above problems, this embodiment proposes the following solutions:

First, design a highly available cloud-edge-device collaborative authentication architecture that adaptively initiates different authentication methods according to different device requirements, reducing complex and repetitive operations at the device end.

Second, during the authentication process, there is no need to frequently rely on the Trust Authority (TA), reducing the load on the Trust Authority.

Third, propose a lightweight authentication method using lightweight algorithms in the authentication process, reducing authentication overhead.

Finally, various entities in the authentication protocol generate associated authentication credentials during registration, and only need to use these credentials during authentication without revealing device privacy.

In summary, this embodiment designs a highly scalable and adaptive cloud-edge-device collaborative authentication architecture that, through the collaborative work of devices, edge servers, and cloud servers, satisfies users' requirements for diversity and real-time performance. This scheme does not rely on the Trust Authority during the authentication process, reducing the burden and security risks of the Trust Authority, while adopting lightweight authentication methods and associated authentication credential methods, making it suitable for resource-constrained IoT devices with high practicality and security.

This embodiment designs an adaptive and highly scalable cloud-edge-device collaborative authentication architecture: this architecture can effectively satisfy the real-time requirements of devices. During the authentication process, devices can first send service requests to edge servers. If edge servers cannot satisfy service requirements, they automatically request assistance from cloud servers. During the service request process, this architecture can adaptively initiate different authentication methods, thereby reducing complex device operations and improving the efficiency of the authentication process. This design not only enhances system flexibility and response speed but also ensures that various devices can obtain optimal services under different circumstances.

This embodiment proposes an edge server-assisted authentication architecture: under this architecture, the authentication process no longer frequently relies on third-party Trust Authorities (TA). With only the assistance of edge servers, bidirectional anonymous authentication between devices and edge servers, and between devices and cloud servers can be achieved. By reducing dependence on the Trust Authority, this not only reduces the burden on the Trust Authority but also reduces security risks caused by frequent computations by the Trust Authority. This bidirectional anonymous authentication mechanism improves system security and reliability.

This embodiment proposes a lightweight authentication method: this method uses only hash-based algorithms during the authentication process, avoiding complex Elliptic Curve Cryptography (ECC) operations, thereby significantly reducing computational overhead in the authentication process. The lightweight authentication method makes this scheme particularly suitable for various resource-constrained IoT devices, ensuring that even devices with limited performance can perform efficient authentication operations, enhancing the overall system's applicability and practicality.

This embodiment introduces the use of associated authentication credentials in the authentication protocol: various entities generate associated authentication credentials during registration, and in subsequent authentication processes, only need to use these credentials to complete authentication. This design ensures the efficiency and security of the authentication process. By pre-generating and using associated credentials, the complexity and time consumption of real-time computation are reduced, further improving the efficiency of authentication operations.

This scheme consists of five phases. The first phase is system initialization, where the Trust Authority (TA) allocates public parameters for the system. The second phase is where users, devices, edge servers (ESs), and cloud servers (CSs) legitimately register with the Trust Authority to obtain necessary credentials for authentication. The third phase is where users must perform necessary device login operations before proceeding with subsequent processes. The fourth phase is the authentication and key agreement phase before devices request various services. This phase can be divided into two situations: the first situation is bidirectional authentication and key agreement between devices and ESs; the second situation is bidirectional authentication and key agreement between devices and multiple CSs with ES assistance. The fifth phase is user password update.

### Phase 1: System Initialization

In this phase, the Trust Authority initializes the system's Hash functions for hash computation and publishes these parameters publicly within the network. Every entity in the network can calculate required authentication credentials based on these public parameters. The Trust Authority selects a series of secure hash functions h:{0,1}*→{0, 1}¹.

### Phase 2: Registration Phase

In this phase, Users, Devices, ESs, and CSs respectively provide registration information to the Trust Authority through secure channels for identity registration.

### Cloud Server CS Registration:

In this stage, CSₖ first selects its identity identifier CIDₖ, then submits its registration request {CIDₖ, Services} to the Trust Authority through a secure channel, where Services represents the types of services CSₖ can provide. Upon receiving the registration request, the Trust Authority first checks whether CIDₖ is legitimate, such as whether it is a duplicate registration; if illegitimate, it rejects the request. If legitimate, it generates long-term public-private keys (SKₖ,PKₖ) for CIDₖ based on ECC algorithm or other algorithms. It should be noted that (SKₖ,PKₖ) has a strong binding relationship with CIDₖ for CIDₖ's use in other future scenarios. Finally, it calculates the secret value SCₖ=h(s∥X) for SCₖ, where X is optional and can be any value but cannot duplicate with other entities during registration.

The message {SCₖ,SKₖ} is returned to cloud server CSₖ. Finally, the Trust Authority stores {identity identifier CIDₖ, PKₖ, Services} to ListCS( ), and CS stores {SCₖ, SKₖ}.

### ES Registration:

(1) ESⱼ first selects its identity identifier EIDⱼ, then submits its registration request {EIDⱼ} to the Trust Authority through a secure channel.
(2) Upon receiving the registration request, the Trust Authority first checks whether EIDⱼ is legitimate, such as whether it is a duplicate registration; if illegitimate, it ignores the request. If legitimate, it generates long-term public-private keys (SKⱼ, PKⱼ) for EIDⱼ based on ECC algorithm or other algorithms. It should be noted that (SKⱼ, PKⱼ) has a strong binding relationship with EIDⱼ for EIDⱼ's use in other future scenarios. Then it generates authentication credential SEⱼ=h(s∥X) for ESⱼ, where X is optional and can be any value but cannot duplicate with other entities during registration. SEⱼ is used to verify Device identity.

Then, the Trust Authority traverses ListCS( ) to generate associated authentication credentials corresponding to each CS for ESⱼ. For convenience of description, this embodiment simply explains the process of ESⱼ generating associated authentication credentials with a single CS (CSₖ):

To achieve anonymity in authentication between ESⱼ and CSₖ, the Trust Authority calculates pseudonym pid^{(x)}_{j,k}=h(Y) for ESⱼ's authentication with CSₖ, where Y can be any value that cannot be the same as other entities during registration, and the generated pseudonyms can be one or multiple, as well as multiple authentication credentials C^{(x)}_{j,k}=h(pid(x)_{j,k}∥SCₖ), where SCₖ is the secret value of cloud server CS_k. Finally, the response message {SKⱼ, (Wₖ, PID_{j,k}, C_{j,k})} is returned to ESⱼ, where PID_{j,k}={pid⁽¹⁾_{j,k}, pid⁽²⁾_{j,k}, . . . , pid⁽ⁿ⁾_{j,k}}, C_{j,k}={C⁽¹⁾_{j,k}, C⁽²⁾_{j,k}, . . . , C⁽ⁿ⁾_{j,k}}, and Wₖ is any public identifier that can identify CSₖ's identity.
(3) Upon receiving the response message from the Trust Authority, ES_j saves {SKⱼ, (Wₖ, PID_{j,k}, C_{j,k})} to ListE2C( ), while the Trust Authority saves {EIDⱼ, PKⱼ, (PID_{j,k})} to ListES( ).

It should be noted that the (Wₖ, PID_{j,k}, C_{j,k}) generated in the above registration process is the anonymous identity and authentication credentials for communication between ESⱼ and CSₖ. In actual situations, when ESⱼ registers, the Trust Authority will customize and select a CS sequence from the registered CS list based on the preferences and geographical location information provided, generating multiple (Wₓ, PID_{j,x}, C_{j,x}) for ESⱼ, thus providing more services for devices under ESⱼ's range.

### User and Device Registration:

(1) First, the device user selects their username UIDᵢ and password PW_i, then calculates hash value EPWᵢ=h(UIDᵢ∥PWᵢ), and finally submits {UIDᵢ, IDᵢ, EPWᵢ, INFO} to the Trust Authority, where IDᵢ is the identifier of device Dᵢ, and INFO contains user's behavioral preferences and geographical location and other information.
(2) Upon receiving the registration request, the Trust Authority first calculates the unique communication identifier DIDᵢ=h (UIDᵢ∥IDᵢ∥s) combining UIDᵢ and IDᵢ, then checks whether DIDᵢ is legitimate, such as whether it is a duplicate registration; if illegitimate, it ignores the request. If legitimate, it generates long-term public-private keys (SKᵢ, PKᵢ) for DIDᵢ using ECC algorithm or other algorithms.

The Trust Authority then selects the most suitable ES sequence for DIDᵢ based on INFO content. For convenience of description, this embodiment simply explains the process of DIDᵢ generating associated authentication credentials with a single ES (ESⱼ):

To ensure anonymity and unlinkability of user authentication, the Trust Authority calculates pseudonym pid^{(x)}_{i,j}=h(Y) for DIDᵢ's authentication with ESⱼ, where Y can be any value that cannot be the same as other entities during registration, and the generated pseudonyms can be one or multiple, as well as multiple authentication credentials a^{(x)}_{i,j}=h(pid^{(x)}_{i,j}∥SEⱼ), where SEⱼ is the secret value of edge server ESⱼ. Then it calculates b^{(x)}_{i,j}=EPWᵢ⊕a^{(x)}_{i,j}.

Finally, the response message {SKᵢ,(Wⱼ, PID_{i,j}, B_{i,j})} is returned to Dⱼ, where PID_{i,j}={pid⁽¹⁾_{i,j}, pid⁽²⁾_{i,j}, . . . , pid⁽ⁿ⁾_{i,j}}, B_{i,j}={b⁽¹⁾_{i,j}, b⁽²⁾_{i,j}, . . . , b⁽ⁿ⁾_{i,j}} and Wⱼ is any public identifier that can identify ESⱼ's identity.
(3) Dᵢ calculates Qᵢ=H(UIDᵢ∥IDᵢ∥PWᵢ), where Qᵢ is used for user UIDᵢ to login to Dᵢ. Dᵢ saves {Qᵢ, SKᵢ, (Wⱼ, PID_{i,j}, B_{i,j})} to ListD2E( ). The Trust Authority saves {DIDᵢ, (UIDᵢ, IDᵢ), PKᵢ, (PID_{i,j})} to ListDID( ).

### Phase 3: Login Phase

Login is a prerequisite for authentication and key agreement. This process mainly describes the process of User_i logging into device Dᵢ. First, the user inputs UIDᵢ, IDⱼ, PWᵢ, and Dᵢ calculates Qᵢ′=H(UIDᵢ∥IDⱼ∥PWᵢ), determining whether Qᵢ′ is the same as Qᵢ; if the same, login succeeds; if different, login fails.

### Phase 4: Authentication and Key Agreement Phase

If Userᵢ successfully logs into Dᵢ, Dᵢ sends its request message to ESs within its geographical range rather than broadcasting the message to CSs. Then, ES verifies the legitimacy of Dᵢ through authentication; if Dᵢ is legitimate and has been registered, ES provides services according to user requests. To improve the response efficiency of user requests, this embodiment defines two modes.

The first mode is if ES itself has the capability to fulfill the user's service requirements, then authentication and key agreement between Dᵢ and ES are performed directly.

The second mode is if ES itself cannot satisfy the user's service requirements, then it recommends the best CS services to the user, which may be one or multiple CSs. Subsequently, Dᵢ and CS complete authentication and session key agreement with ES assistance. It should be noted that how to select appropriate cloud service providers is beyond the scope of this scheme.
Mode 1: This mode occurs when the services provided by ESⱼ can already satisfy user requirements, so ESⱼ does not need to request cloud services. Only mutual authentication between Dᵢ and ESⱼ is needed. The mutual authentication process is as follows:
Step 1: Dᵢ actively initiates an authentication request to ESⱼ. At this time, Dᵢ has already received the public identifier Wⱼ broadcast by ESⱼ within its control range. Calculate: EPWᵢ=H (DIDᵢ∥PWᵢ). Dᵢ randomly selects pid^{(x)}_{i,j} from PID_{i,j} to authenticate with ESⱼ, calculates a^{(x)}_{i,j}′=EPWᵢ⊕b^{(x)}_{i,j}, then randomly generates x₁, calculates M₁=a^{(x)}_{i,j}′⊕x₁, calculates hash value α=h(SerReq,pid^{(x)}_{i,j}, x₁, Tᵢ). Then sends {SerReq, pid^{(x)}_{i,j}, M₁, α, Tᵢ} to ES_J.
Step 2: Edge server: Upon receiving Dᵢ's authentication request information {SerReq, pid^{(x)}_{i,j}, M₁, α, Tᵢ}, ESⱼ first performs timestamp Tᵢ verification; if Tᵢ has expired, it rejects the authentication request. Otherwise, it calculates: Aᵢⱼ=H(pid^{(x)}_{i,j}∥SEⱼ), and obtains the value x₁′ where x₁′=Aᵢⱼ⊕M₁, then calculates hash value α′=h(SerReq, pid^{(x)}_{i,j}, x₁′, Tᵢ). It determines whether α is the same as α′; if different, device Dᵢ authentication fails. Otherwise, Dᵢ authentication passes. Then, it checks information SerReq; if it finds it cannot satisfy device service requirements, it jumps to mode 2; if it can satisfy them: randomly generates x₂, calculates M₂=Aᵢⱼ⊕x₂, generates session key skⱼᵢ=h(Aᵢⱼ∥x₁′∥x₂); extracts timestamp T_j, calculates hash value β=h(skⱼᵢ, x₂, Tⱼ), and finally returns message {M₂,β,Tⱼ} to Dᵢ.
Step 3: Upon receiving ESⱼ's authentication response information {M₂,β,Tⱼ}, Dᵢ first performs timestamp Tⱼ verification; if T has expired, it rejects the authentication request. Otherwise, it calculates x₂=M₂⊕a^{(x)}_{i,j}′, and calculates session key skᵢⱼ=h(a^{(x)}_{i,j}′∥x₁∥x₂). It calculates hash value β′=h(skᵢⱼ, x₂′, Tⱼ). It determines whether β is the same as β′; if different, ESⱼ authentication fails. Otherwise, ESⱼ authentication passes, and stores session key sessionKey=skᵢⱼ.
Mode 2: This phase occurs when the services provided by ESⱼ cannot satisfy user requirements, and ESⱼ needs to request cloud services for Dᵢ. This authentication method is also applicable to multi-cloud environments. Since user service requirements are diverse, ESⱼ can simultaneously select multiple cloud services for users, and these selections are transparent to users, meaning ES assists authentication between users and CSs. The specific process is as follows:
Step 1: Same as Mode 1, no repetition here.
Step 2: The steps before checking information SerReq are also the same as Mode 1, no repetition here.

Check information SerReq, find that device service requirements cannot be satisfied, then select appropriate CSs based on user requests. Calculate S_{i,j}=h(A_{i,j}∥x₁′), M₃=S_{i,j}⊕C_{j,k}, θ=h(SerReg∥pid_{j,k}∥S_{i,j}∥Tₖ). Send {SerReq, pid_{j,k}, M₃, θ, Tₖ} to CSₖ.
Step 3: First perform timestamp Tₖ verification; if Tₖ has expired, reject the authentication request. Otherwise, calculate A_{j,k}=h(pid_{j,k}∥SCⱼ), S′_{i,j}=M₃⊕A_{j,k}, θ′=h(SerReg∥pid_{j,k}∥S′_{i,j}∥Tₖ), determine whether θ is the same as θ′; if different, authentication fails; if the same, generate random number x₃, calculate S_{j,k}=h(A_{j,k}∥x₃), M₄=S_{j,k}⊕A_{j,k}, skₖᵢ=h(S′_{i,j}∥S_{j,k}), υ=h(skₖᵢ∥S_{j,k}∥T₁), where Tᵢ is a timestamp. Then send {M₄, υ, T₁} to ESⱼ.
Step 4: First perform timestamp T₁ verification; if T₁ has expired, reject the authentication request. Otherwise, calculate S′_{j,k}=M₄⊕C_{j,k}, sk′ᵢₖ=h(S′_{i,j}∥S′_{j,k}), υ′=h(skₖᵢ∥S′_{j,k}∥T₁), determine whether υ′ is the same as υ′; if different, authentication fails; if the same, calculate M₅=S′_{j,k}⊕A_{i,j}, ε=h(sk′ₖᵢ∥S′_{j,k}∥Tₘ₎, where Tₘ is a timestamp. Then send {M₅, υ, Tₘ} to Dᵢ.
Step 5: Upon receiving ESⱼ's authentication response information {M₅, υ, Tₘ}, Dᵢ first performs timestamp Tₘ verification; if Tₘ has expired, it rejects the authentication request. Otherwise, it calculates S″_{i,j}=h(a^{(r)′}_{i,j}∥x₁), S″_{j,k}=M₅⊕a^{(r)′}_{i,j}, ε′=h(sk′ₖᵢ∥S″_{j,k}∥Tₘ), determines whether ε′ is the same as ε; if different, ESⱼ and CSₖ authentication fails. Otherwise, ESⱼ and CSₖ authentication passes, and stores session key sessionKey=skᵢⱼ.

The authentication and key agreement phase in this embodiment considers authentication under cloud-edge-device collaborative scenarios. User devices only need to send one authentication request message. If the edge satisfies requirements, the user device directly performs identity authentication and key agreement with the edge. If the edge does not satisfy requirements, the authentication message is adaptively processed and forwarded to an appropriate cloud, ultimately achieving identity authentication and key agreement between the cloud and user device, meaning the user device does not need to frequently or repeatedly send authentication request information.

The adaptive and highly scalable cloud-edge-device collaborative authentication architecture designed in this embodiment can effectively satisfy various device requirements, adaptively execute different authentication methods, and reduce complex operations at the device end. The edge server-assisted authentication architecture proposed in this embodiment no longer frequently relies on third-party Trust Authority during authentication and key agreement processes, reducing the load on the Trust Authority. The lightweight authentication method proposed in this embodiment is suitable for various network resource-constrained scenarios, increasing deployability. The use of associated authentication credentials in this embodiment reduces the complexity of real-time computation and time consumption while protecting device privacy.

The above description is only for preferred specific embodiments of this application, but the protection scope of this application is not limited thereto. Any person familiar with this technical field can easily conceive changes or substitutions within the technical scope disclosed in this application, which should be covered within the protection scope of this application. Therefore, the protection scope of this application should be based on the protection scope of the claims.

What is claimed is:

1. An adaptive identity authentication and key agreement method in a cloud-edge-end environment, characterized by comprising:
step 1: utilizing a trust authority to perform identity registration for users, devices, edge servers, and cloud servers; after identity registration is completed, a user logs into a device and sends request information of the user to edge servers within a predetermined range through the logged-in device;
wherein the identity registration process for the cloud server specifically comprises: the cloud server submits a cloud server registration request to the trust authority, the cloud server registration request including a cloud server identity identifier and types of services provided; after the trust authority receives the cloud server registration request, the trust authority performs legitimacy verification on the cloud server identity identifier, and if legitimate, generates long-term public and private keys based on the cloud server identity identifier, and calculates a secret value of the cloud server based on hash operations; the trust authority stores the calculated secret value, public key, and service types, and sends the calculated secret value and private key to the cloud server, completing the identity registration of the cloud server;
wherein the identity registration process for the edge server specifically comprises: the edge server submits an edge server registration request to the trust authority, the edge server registration request including an edge server identity identifier; after the trust authority receives the edge server registration request, the trust authority performs legitimacy verification on the edge server identity identifier, and if legitimate, generates long-term public and private keys based on the edge server identity identifier, and calculates authentication credentials of the edge server based on hash operations; the trust authority generates associated authentication credentials corresponding to each cloud server for the edge server, and returns a response message to the edge server, the response message including a private key of the edge server, a public identifier of the cloud server identity, authentication credentials, and a pseudonym for authentication between the edge server and the cloud server; storing the edge server identity identifier, public key, and the pseudonym for authentication between the edge server and the cloud server in the trust authority, completing the identity registration of the edge server;
wherein the identity registration process for the user and the device specifically comprises: the user selects a username and password, performs hash operation on the username and the password to obtain an encrypted password, and submits the calculated encrypted password, username, device identifier, behavioral preferences, and geographic location as a user registration request to the trust authority; after the trust authority receives the user registration request, the trust authority calculates a unique communication identifier based on the username and device identifier, performs legitimacy verification on the unique communication identifier, and if legitimate, generates long-term public and private keys based on the unique communication identifier, and generates associated authentication credentials corresponding to each edge server for the unique communication identifier based on behavioral preferences and geographic location; calculating user login data on the device based on the username, device identifier, and password, causing the device to store the user login data, private key, and a pseudonym for authentication between the unique communication identifier and the edge server, causing the trust authority to store the unique communication identifier, username, device identifier, public key, and the pseudonym for authentication between the unique communication identifier and the edge server, completing the identity registration of the user and the device;
step 2: after receiving the request information, the edge server performs legitimacy verification on the device logged in by the user, and after verification is passed, provides services to the user based on the request information;
step 3: during the process of providing services to the user, determining whether the service capability of the edge server satisfies the request information; if yes, performing authentication and key agreement between the edge server and the device logged in by the user, and after completion, providing services to the user; if no, adaptively selecting a cloud server to perform authentication and key agreement with the device logged in by the user, and after completion, providing services to the user;
wherein step 3 specifically comprises:
the device initiates an authentication request to the edge server, the authentication request including a service request, a pseudonym, a first random number, a timestamp, a first message authentication code, and a hash calculation value, the hash calculation value being obtained by performing hash operation on the service request, pseudonym, random number, and timestamp;
after the edge server receives the authentication request, determining whether the timestamp has expired; if expired, rejecting the authentication request; if not expired, calculating a current hash calculation value, and determining whether the current hash calculation value is consistent with the hash calculation value in the authentication request; if inconsistent, authentication fails; if consistent, authentication succeeds, and determining the service capability; if the service capability of the edge server does not satisfy the request information, selecting a cloud server to perform authentication and key agreement with the device logged in by the user, and after completion, providing services to the user; if the service capability of the edge server satisfies the request information, performing authentication and key agreement between the edge server and the device logged in by the user, and after completion, providing services to the user;
wherein performing authentication and key agreement between the edge server and the device logged in by the user specifically comprises:
randomly generating a second random number, calculating a second message authentication code based on the second random number, generating a session key and extracting a current timestamp, calculating a hash value based on the second random number, current timestamp, and session key, and sending the calculated hash value, current timestamp, and second message authentication code as an authentication message to the device;
after the device receives the authentication message, determining whether the timestamp has expired; if expired, rejecting the authentication request; if not expired, calculating a current hash value based on the second message authentication code, and comparing the current hash value with the hash value in the authentication message; if different, authentication fails; if identical, authentication passes, and storing the session key;
wherein adaptively selecting a cloud server to perform authentication and key agreement with the device logged in by the user specifically comprises:
calculating a third message authentication code, and calculating a current hash value based on the third message authentication code, pseudonym, and timestamp, and sending the calculated hash value, third message authentication code, pseudonym, timestamp, and service types to the selected cloud server;
after the cloud server receives the data, determining whether the timestamp has expired; if expired, rejecting the authentication request; if not expired, calculating a fourth message authentication code, and determining whether the current hash operation value is consistent with the hash value in the data received by the cloud server; if inconsistent, authentication fails; if consistent, authentication passes, and sending the calculated hash value, fourth message authentication code, and current timestamp to the edge server for verification; determining whether the timestamp has expired; if expired, rejecting the authentication request; if not expired, calculating a fifth message authentication code, and determining whether the current hash operation value is consistent with the hash value in the data received by the edge server; if inconsistent, authentication fails; if consistent, authentication passes, and sending the calculated hash value, fifth message authentication code, and current timestamp to the device; after the device receives the data, determining whether the timestamp has expired; if expired, rejecting the authentication request; if not expired, calculating a current hash operation value based on the fifth message authentication code, determining whether the current hash operation value is consistent with the hash value in the data received by the device; if inconsistent, authentication fails; if consistent, authentication passes, and storing the session key.

2. The adaptive identity authentication and key agreement method in a cloud-edge-end environment according to claim 1, characterized in that, before utilizing the trust authority to perform identity registration for users, devices, edge servers, and cloud servers, the method further comprises: utilizing the trust authority to initialize Hash functions for system hash calculation, and publishing the calculated parameters publicly within the network, completing system initialization.

3. The adaptive identity authentication and key agreement method in a cloud-edge-end environment according to claim 1, characterized in that, the user logging into the device specifically comprises:
the device calculates current user login data based on the username, device identifier, and password input by the user; if the current user login data is consistent with preset user login data, login succeeds; if the current user login data is inconsistent with preset user login data, login fails.
